(19) United States
(12) Patent Application Publication
(10) Pub. No.: US 2015/0336124 A1
(43) Pub. Date: Nov. 26, 2015

(54) DISCHARGE DEVICE FOR A FLUID MEDIUM

(71) Applicant: MeadWestvaco Calmar GmbH, Hemer (DE)

(72) Inventor: Gisbert Welp, Sundern (DE)

(21) Appl. No.: 14/647,396

(22) PCT Filed: Nov. 25, 2013
(86) PCT No.: PCT/EP2013/003554

§ 371 Date: May 26, 2015

(30) Foreign Application Priority Data
Nov. 28, 2012 (DE) 10 2012 023 216.0

(51) Int. Cl. B05B 11/00

(52) U.S. Cl. CPC B05B 11/3019; B05B 11/0037

(57) ABSTRACT

Discharge device for a fluid medium, with a reservoir (1), a pump part (2) which can be secured on the reservoir (1) and conveys medium from the reservoir (1) to a discharge opening (3), and an actuation mechanism (8) which engages with a head part (9) on the pump part (2) and generates a relative movement between pump part (2) and reservoir (1) in a stroke direction (X), wherein the actuation mechanism (8) is provided in the form of a pressure stroke mechanism which comprises a flexible spring (11), with at least two legs (12, 13) articulated on the head part (9) and each pretensioned in an arc shape and having a gripping jaw (14, 15) at one end, and a workpiece (16) guiding the gripping jaws (14, 15), and the workpiece (16) is in engagement with the reservoir (1) in order to guide the gripping jaws (14, 15) for a force transfer and movement of the reservoir (1) with respect to the pump part (2) in the stroke direction (X), the legs (12, 13) pretensioned in an arc shape being subjected to an elastically restoring load by being pressed together.

The invention relates to a discharge device for a fluid medium in accordance with the preamble of claim 1.

DE 44 00 945 A1 discloses a fluid-dispensing device of this kind that is used in particular for spraying sterile liquids, e.g. eye drops. The pump part, sitting sealingly on a fluid container, and the actuation element, fitted on the pump part, are protected against accidental removal. At the same time, comfortable and safe handling of the fluid-dispensing device is also ensured. For this purpose, a sleeve part is arranged to be displaceable along at least the actuation path of a dosing pump, such that an actuation of the dosing pump is possible.

This sleeve part has a circular recess on its top and is pushed over the actuation element, such that the upper tip of the actuation part with the fluid outlet protrudes through the circular recess, and the sleeve part rests on a plate-shaped portion of the actuation element. In the lower area, the cylindrical fluid container has an annular projection, over which the sleeve part is pushed for fixing it. The distance of the outer projection from the bottom of the fluid container corresponds at least to the actuation path of the actuation element but is chosen such that an outer circumferential surface area that is as great as possible is present on the sleeve part.

A disadvantage is that although the sleeve element encases the actuation function between the actuation element and the pump part, as a result of which the handling of the fluid-dispensing device is made safer, this is done at the cost of comfort, which leads to a bulky shape of the fluid-dispensing device. Moreover, when actuated overhead, particularly for eye drops, the sleeve part is a slight hindrance, since the precision feel needed for dispensing a dosed amount of fluid is lost on account of the screening effect of the sleeve part. Finally, the sleeve part, as screening element, has no function itself in the actuating procedure. The enhanced comfort therefore increases the weight and complexity of the fluid-dispensing device, which is likewise disadvantageous.

DE 295 05 359 U1 discloses a pump sprayer with an attached cap. Provided inside the cap is a lever arrangement, comprising two actuating levers, pivotable relative to each other in a plane, and a link connected to these actuating levers. A link is articulated at bending points of the actuating levers. The connection piece has an approximately V-shaped configuration, with the central piece forming a projecting tip, of which the downward excursion triggers the pump movement of the spray head for spraying the liquid in the pump spray.

DE 602 17 545 T2 discloses an spray device with an actuation system which is formed on the dispenser head, wherein the direction of movement or adjustment of the actuation mechanism differs from the spray direction of the product through the dispenser orifice.

DE 100 32 976 A1 discloses a discharge device for media, in which the actuating direction of the actuation element of the discharge device deviates from the stroke direction of the pump element of the discharge device.

On account of the use of a pump element, a coaxial arrangement of pump element and media container is needed. The arrangement of the pump element and of its main axis of extent thus also determines the actuating direction of the actuation element, which lies in the axis of the pump element or in the main axis of the container. However, this actuating orientation of the actuation element is not always the ergonomically most favourable arrangement of the actuation element. The media container is therefore held and guided in a housing, with respect to which the media container is movable.

A discharge stroke via this relative movement can be generated, for example, via an actuation element that acts on the media container via a separate deflection means. This deflection means can be a pivotable lever that generates a force acting on the media container. A disadvantage is in turn the need for an enclosure in the form of a housing, which guides the media container as it were like a slide, such that the actuating direction is not determined by the direction in which force is introduced, but by the guiding in the housing. The use of force-deflecting means arranged on the housing is thereby possible. A disadvantage is once again the complex design and the need to encase the media container, which almost excludes a precision feel for actuation of the dispensing device. The user is as it were taken by surprise by the spray, since the movement of the discharge stroke is not visible.

As dosing accuracy is very important in pharmaceutical uses and is subject to strict requirements, this has to be classed as a clear disadvantage.

An object of the invention is therefore to provide a discharge device which dispenses a fluid medium and which can be actuated simply and reliably and is easy to handle.

This object is achieved by the features of claim 1.

A discharge device is thereby made available in which the stroke direction of the pump part for conveying medium from the reservoir to the discharge opening and the actuating direction of the actuation mechanism are different from each other. By pressing together a flexible spring, of which the slide parts in the form of gripping jaws are moved on a workpiece, a free movement of the gripping jaws during use generates a pressure force in the stroke direction. The force-displacement characteristic of an arc-shaped or curved flexible spring, which can be pressed together on its legs by a finger pressure, provides pressure forces that move the pump part and the reservoir relative to each other. A stroke for dispensing medium is thus generated. By clamping the flexible spring according to the pressure principle by a finger grip or hand grip, an elastic stroke movement takes place which, in addition, preferably functions for only a short time, for as long as the finger grip or hand grip exerts a pressure. The ergonomics of the discharge device are substantially improved.

In a preferable coaxial arrangement of pump part and reservoir, it is possible, in the axis of the pump part, in which the main axis of the reservoir also lies, for a directly acting lifting force to be exerted in the stroke direction by an actuation mechanism. The compressing force engages laterally on the actuation mechanism.

The flexible spring with the at least two legs allows the actuation mechanism to be designed in the manner of a claw that grips the workpiece, for example the reservoir, and can make a connection between pump part and reservoir. Such an actuation mechanism permits the use of a force pairing, by exerting a pressure on a workpiece surface, for example. The force pairing can be combined with a shape pairing, in which the gripping jaws are embedded or enclosed with a shape fit in grooves of the workpiece.

The gripping jaws are stiffened for increasing the resistance to deformation, i.e. for greater stiffness. For example, material reinforcements, stiffening ribs, etc., are suitable for this purpose.

The flexible spring is preferably made of a plastic, in particular polypropylene (PP) or polyoxymethylene (POM).

Further embodiments of the invention are set forth in the following description and in the dependent claims.

The invention is explained in more detail below on the basis of the illustrative embodiments shown in the attached figures.

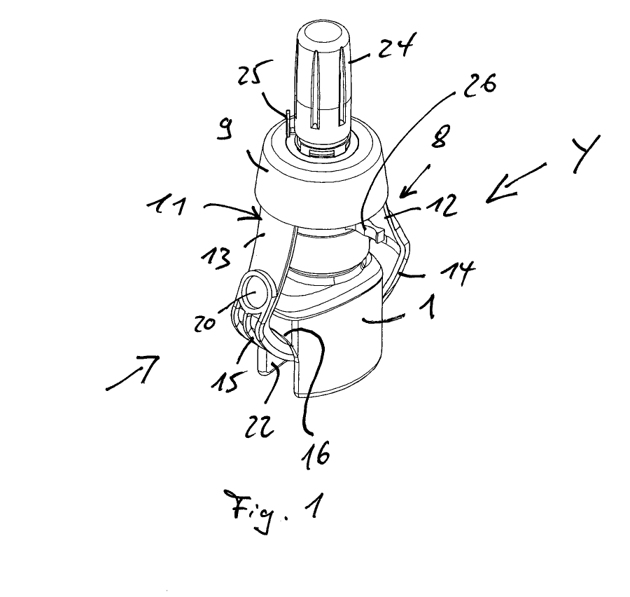

FIG. 1 shows a schematic and perspective view of a discharge device,

FIG. 2 to FIG. 5 show schematically parts of the discharge device according to FIG. 1, in an assembly sequence and after removal of a perforated freshness seal,

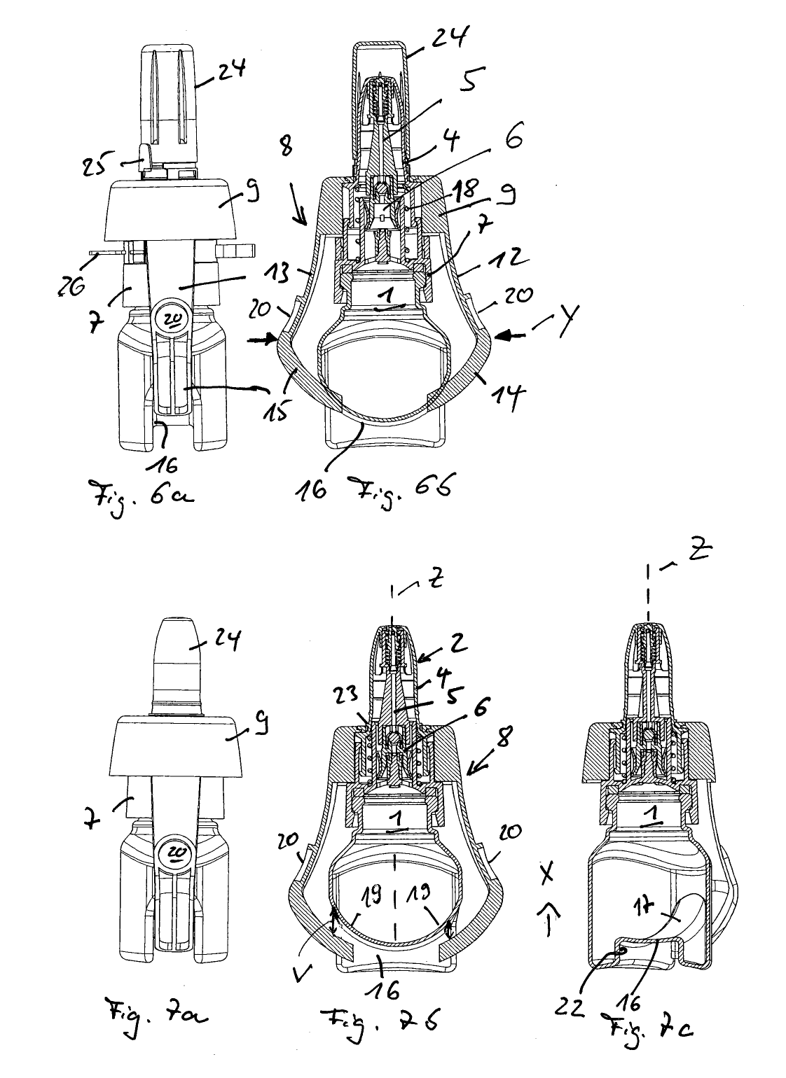

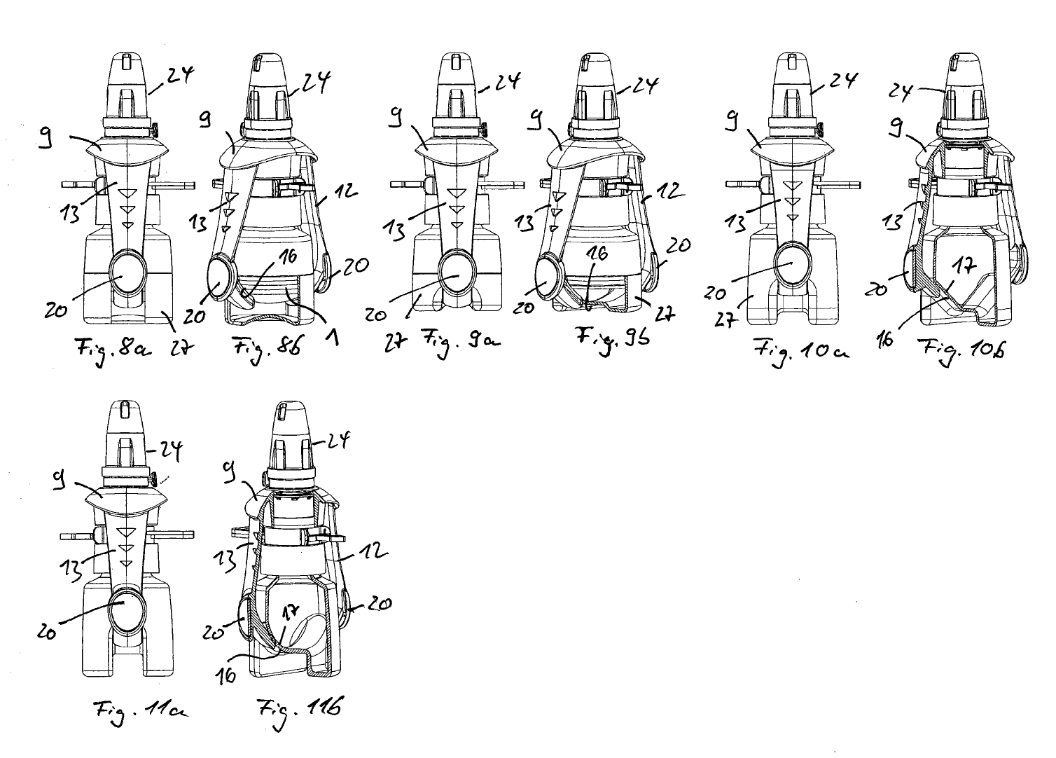

FIG. 6a and FIG. 6b show schematically a side view and a cross section of the discharge device according to FIG. 1 in a rest position,

FIG. 7a to FIG. 7c show schematically a side view and two cross sections of the discharge device according to FIG. 1 in an actuation position,

FIG. 8a and FIG. 8b show schematic views, in partial section, of a further illustrative embodiment of a discharge device,

FIG. 9a and FIG. 9b show schematic views, in partial section, of a further illustrative embodiment of a discharge device,

FIG. 10a and FIG. 10b show schematic views, in partial section, of a further illustrative embodiment of a discharge device,

FIG. 11a and FIG. 11b show schematic views, in partial section, of a further illustrative embodiment of a discharge device.

The invention relates to a discharge device for dispensing a fluid medium from a reservoir 1, as shown in FIG. 1. For this purpose, a pump part 2 can be secured on the reservoir 1 in order to convey medium from the reservoir 1 to a discharge opening 3. The pump part 2 is movable with a stroke movement relative to the reservoir 1 between a lower actuation position and an upper rest position in a stroke direction X. Between the pump part 2 and the reservoir 1, a relative movement in the stroke direction X for conveying medium is generated by manual actuation.

The pump part 2 can be configured in a known manner, for example as described in DE 10 2008 027 598 A1.

As FIG. 6b shows, the pump part 2 accordingly comprises a discharge nozzle 4 with a media channel 5, which is connected to a pump chamber 6 delimited by a valve. When the pump part 2 is actuated in the stroke direction X, medium is conveyed out of the reservoir 1 through the pump chamber 6. The discharge nozzle 4 is pretensioned by a spring 18 relative to a collar 7 secured on the reservoir 1, as a result of which the pump part 2 is axially displaceable in order to perform the stroke movement in the stroke direction X. The pump part 2 and the reservoir 1 are preferably arranged coaxially here.

To actuate the pump part 2, an actuation mechanism 8 is provided. The actuation mechanism 8 has a head part 9, via which the actuation mechanism 8 engages on the pump part 2. The actuation mechanism 8 serves to move the pump part 2 with respect to the reservoir 1 between a lower actuation position and an upper rest position, i.e. to execute the stroke movement in the stroke direction X in order to dispense medium through the discharge opening 3. The pump part 2 can be designed for a dosed discharge of medium. The head part 9 is preferably supported on a plate-shaped collar 10 of the pump part 2 or is positioned bearing thereon.

As FIG. 1 shows in conjunction with FIG. 2 to FIG. 4, the actuation mechanism 8 is provided in the form of a pressure stroke mechanism, which comprises a flexible spring 11 with at least two legs 12, 13 which are articulated on the head part 9 and are each pretensioned in an arc shape. The legs 12, 13 carry gripping jaws 14, 15 at their ends.

As FIG. 6a, FIG. 6b and FIG. 7a to FIG. 7c show, the actuation mechanism 8 includes a workpiece 16 guiding the gripping jaws 14, 15. The workpiece 16 is in engagement here with the reservoir 1. The workpiece 16 guides the gripping jaws 14, 15 and permits a force transfer and a movement of the reservoir 1 with respect to the pump part 2 in the stroke direction X, the legs 12, 13 pretensioned in an arc shape being subjected to an elastically restoring load by being pressed together.

When the pretensioned legs 12, 13 are pressed together, as is indicated in FIG. 6b by the axial direction (arrow direction) Y, the gripping jaws 14, 15 travel a distance relative to the workpiece 16, preferably on a surface of the workpiece 16. On an inclined plane 17 with a gradient 19 with respect to the main axis Z, this displacement distance leads to an increase in the spacing of the gripping jaws 14, 15 from the pump part 2. The legs 12, 13 as retaining arms therefore trigger the stroke movement in which the gripping jaws 14, 15 lift the reservoir 1 in the stroke direction X. The head part 9 is supported on the collar 10. The force-displacement characteristic of the flexible spring 11 with long spring arms in the form of the at least two legs 12, 13 ensures, when the flexible spring 11 is pressed together, a shifting V (cf. FIG. 7b) of a slide part of the gripping jaws 14, 15 on the workpiece 16, as a result of which the relative movement between flexible spring 11 and reservoir 1 is triggered. The gripping jaws 14, 15 execute a sliding movement with respect to the workpiece 16.

As is shown in FIG. 6a, FIG. 6b and in FIG. 7a to FIG. 7c, the workpiece 16 can be formed on the bottom of the reservoir 1. Alternatively, the workpiece can be formed on a housing 27 that receives the reservoir 1. This is illustrated in FIG. 8a, FIG. 8b to FIG. 11a, FIG. 11b, as will be described below.

The workpiece 16 preferably has at least one groove 22, in which the gripping jaws 14, 15 of the flexible spring 11 lie and are able to slide there with a preferably low coefficient of friction. In the upper rest position of the pump part 2 shown in FIG. 6a and FIG. 6b, the gripping jaws 14, 15 are preferably already in engagement with the workpiece 16, such that, in the unloaded state of the flexible spring 11, the legs 12, 13 can exert a retaining grip on the workpiece 16.

It is advantageous here in particular that, when used to dispense eye drops, the discharge opening 3 does not change position when actuated from overhead, since the reservoir 1 is moved, i.e. as it were lifted, in order to execute the stroke movement.

The at least two legs 12, 13 are preferably formed integrally on the head part 9. The at least two legs 12, 13 are also preferably curved inwards and arranged in series. The at least two legs 12, 13 are then preferably articulated on the head part 9 in the manner of a unilateral double lever with separate rotation points of the legs 12, 13 arranged at a distance from each other at the end of a lever rod.

The at least two legs 12, 13 are preferably designed as in each case flat band material from a resilient substance that is pretensioned in an arc shape in order to introduce force in axis direction Y. The flat plastic band is also preferably bent at an angle.

The flexible spring 11 is preferably made of polypropylene (PP), polyoxymethylene (POM) or polybutylene terephthalate (PBT). For transferring the stroke movement generated by the at least two legs 12, 13 to the workpiece 16, the gripping jaws 14, 15 are stiffened in order to increase the resistance to deformation.

The arc-shaped legs 12, 13 can each have a finger pad 20 in the area of a peak of the curvature of the respective leg arc. The finger pad 20 can be integrally formed from the same material as the legs 12, 13, produced from a soft material by multi-component technology or provided as an add-on part.

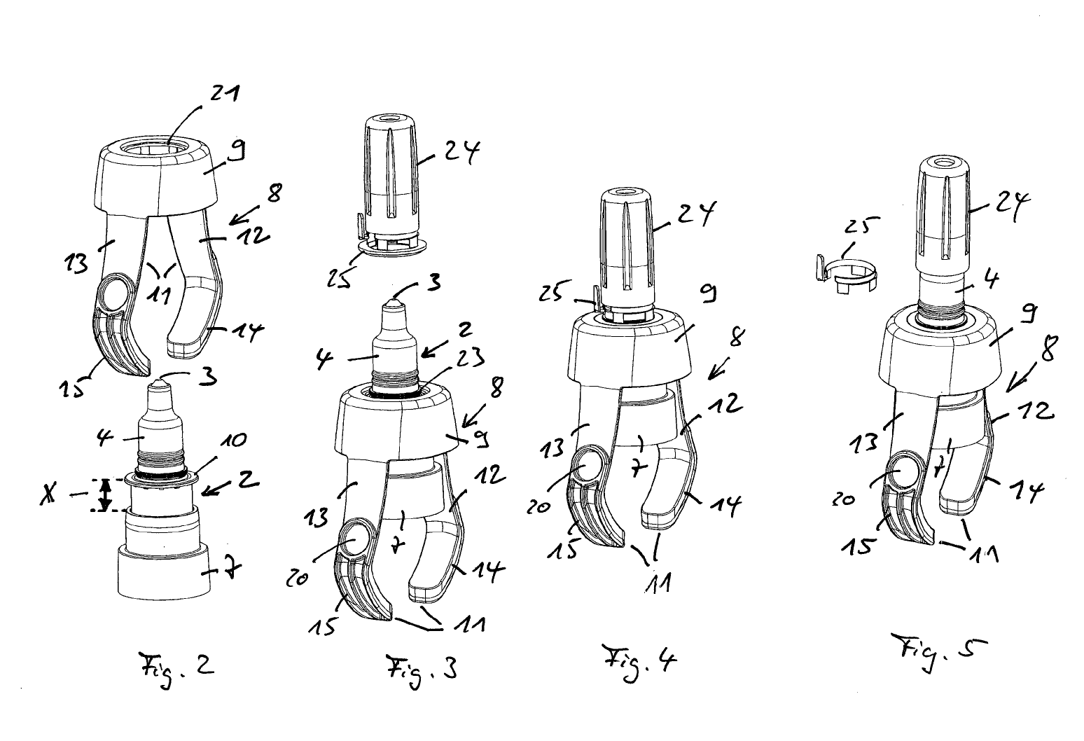

The head part 9 is preferably designed like a cap and can additionally have the shape of a cylinder. The head part 9 can, as a cap-shaped sleeve part, have a recess 21 on its top, through which an upper tip of the pump part 2 can be inserted, as is shown in FIG. 2 and FIG. 3. The head part 9 can be locked with the pump part 2 for securely fastening the head part 9 on the pump part 2. For this purpose, a locking ring 23 can be provided on the pump part 2. The head part 9 can then be lifted off the pump part 2 only by destroying the discharge device.

As is shown in FIG. 3 to FIG. 5, a protective cap 24 can be placed in a known manner onto the discharge nozzle 4. A perforated freshness seal in the form of a tear-off ring 25 can be applied in order to identify a first removal of the protective cap 24. A lifting-movement barrier 26 can also be introduced in a known manner, as is shown in FIG. 1 and FIG. 6a. The locking is preferably obtained via the protective cap 24 with a locking ring 23, which can be integrally formed on the protective cap 24 in order to secure the tear-off ring 25 on the pump part 2 via the head part 9.

The discharge device can be used for any type of fluid medium that can be dispensed through a pump from a reservoir. Liquids are particularly suitable, although it is also possible to use foam-like, gel-like or pasty media.

FIG. 8a and FIG. 8b show another illustrative embodiment of the discharge device with an ergonomically modified head part 9 and finger pads 20, which are arranged on the peak of the curvature of the legs 12, 13. The workpiece 16 is formed on the bottom of the reservoir 1, wherein the reservoir 1 can be encased by a housing 27.

FIG. 9a and FIG. 9b show illustrative embodiments of the discharge device with a workpiece 16 which is formed on the housing 27. The reservoir 1 can thus be designed, particularly in terms of size, shape and/or material, independently of the workpiece 16. FIG. 10a, FIG. 10b and FIG. 11a, FIG. 11b show inclined planes 17 of the workpiece 16 which, for example, are either rectilinear or curved. The housing 27 itself can be designed in several parts.

1. Discharge device for a fluid medium, with a reservoir, a pump part which can be secured on the reservoir and conveys medium from the reservoir to a discharge opening, and an actuation mechanism which engages with a head part on the pump part and generates a relative movement between pump part and reservoir in a stroke direction (X), wherein the actuation mechanism is provided in the form of a pressure stroke mechanism which comprises a flexible spring, with at least two legs articulated on the head part and each pretensioned in an arc shape and having a gripping jaw at one end, and a workpiece guiding the gripping jaws, and the workpiece is in engagement with the reservoir in order to guide the gripping jaws for a force transfer and movement of the reservoir with respect to the pump part in the stroke direction (X), the legs pretensioned in an arc shape being subjected to an elastically restoring load by being pressed together.

2. Discharge device according to claim 1, wherein the at least two legs are formed integrally on the head part and are guided in a sliding movement on inclined planes on the workpiece.

3. Discharge device according to claim 1, wherein the at least two legs are curved inward and arranged in series.

4. Discharge device according to claim 1, wherein the at least two legs are designed in the manner of a unilateral double lever with separate rotation points, arranged at a distance from each other, of the legs at one end of the lever rods, which end is in each case articulated on the head part.

5. Discharge device according to claim 1, wherein the at least two legs are designed as in each case flat band material from a resilient hard substance, which is pretensioned in an arc shape in order to introduce force in axis direction (Y).

6. Discharge device according to claim 5, wherein the flat plastic band is bent at an angle.

7. Discharge device according to claim 1, wherein the flexible spring is made of polypropylene (PP), polyoxymethylene (POM) or polybutylene terephthalate (PBT).

8. Discharge device according to claim 1, wherein the gripping jaws are stiffened such that a stroke movement generated by the at least two legs is transferred to the workpiece.

9. Discharge device according to claim 1, wherein the arc-shaped legs each carry a finger pad in the area of a peak of the curvature of the respective leg arc.

10. Discharge device according to claim 1, wherein the head part is designed like a cap.

11. Discharge device according to claim 1, wherein the head part is designed with a cylindrical shape.

12. Discharge device according to claim 1, wherein the workpiece is formed on the bottom of the reservoir.

13. Discharge device according to claim 1, wherein the workpiece is formed on a housing that receives the reservoir.

14. Discharge device according to claim 1, wherein the workpiece has a groove in which the gripping jaws of the flexible spring lie.

15. Discharge device according to claim 1, wherein the head part, as cap-shaped sleeve part, has, on its top, a recess through which an upper tip of the pump part can be inserted.
